(19) United States
(12) Patent Application Publication
(10) Pub. No.: US 2026/0292695 A1
(43) Pub. Date: Sep. 24, 2026

(54) ADAPTIVE MEASUREMENT OF LOW POWER WAKE-UP SIGNAL OR LEGACY REFERENCE SIGNAL FOR RADIO RESOURCE MANAGEMENT

(71) Applicant: Apple Inc., Cupertino, CA (US)

(72) Inventors: Jie Cui, San Jose, CA (US); Qiming Li, Beijing (CN); Dawei Zhang, Saratoga, CA (US); Haitong Sun, Cupertino, CA (US); Sigen Ye, Whitehouse Station, NJ (US); Yang Tang, San Jose, CA (US)

(21) Appl. No.: 19/473,034

(22) PCT Filed: Apr. 7, 2023
(86) PCT No.: PCT/CN2023/086957

§ 371 Date: Oct. 6, 2025

(51) Int. Cl. H04W 52/02; H04W 76/28

(52) U.S. Cl. CPC H04W 52/0235; H04W 76/28

(57) ABSTRACT

A user equipment (UE) includes a transceiver, a low power wake-up receiver (LP-WUR), and a processor. The processor is configured to receive a configuration of a low power wake-up signal (LP-WUS). The LP-WUS is received from a neighbor cell. The processor is also configured to determine whether a first measurement of a synchronization signal block (SSB) of the neighbor cell, via the transceiver, requires a first measurement gap; and determine, based at least in part on whether the first measurement of the SSB requires the first measurement gap, whether to transmit, to a network, a request to use the LP-WUS for mobility measurement.

### TECHNICAL FIELD

This application relates generally to wireless communication systems, including systems in which a user equipment (UE) uses a low power wake-up receiver (LP-WUR) to monitor for a low power wake-up signal (LP-WUS) transmitted by a network device.

### BACKGROUND

Wireless mobile communication technology uses various standards and protocols to transmit data between a network device (e.g., a base station, a radio head, etc.) and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a network device of the RAN (which may also sometimes be referred to generally as a RAN node, a network node, or simply a node) and a wireless communication device known as a UE. 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the network device and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A network device used by a RAN may correspond to that RAN. One example of an E-UTRAN network device is an Evolved Universal Terrestrial Radio Access Network (E-UTRAN) Node B (also commonly denoted as evolved Node B, enhanced Node B, eNodeB, or eNB). One example of an NG-RAN network device is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example wireless communication system, according to embodiments described herein.

FIG. 2 shows an example method of wireless communication by a UE, according to embodiments described herein.

FIG. 3 shows an example method of wireless communication by a network device, according to embodiments described herein.

FIG. 4 shows another example method of wireless communication by a UE, according to embodiments described herein.

FIG. 5 illustrates an example architecture of a wireless communication system, according to embodiments described herein.

FIG. 6 illustrates an example system for performing signaling between a wireless device and a network device, according to embodiments described herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device.

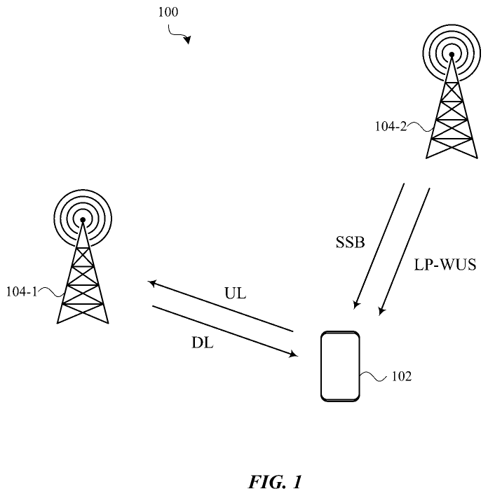

FIG. 1 shows an example wireless communications system 100. The wireless communications system may include a UE 102 that is connected, over the air, to a network (e.g., a 3GPP network). The UE 102 may communicate with the network on one or more uplink (UL) channels and one or more downlink (DL) channels, and more particularly may communicate with one or more network devices of a RAN (e.g., network devices 104-1 and 104-2, which may take the form of one or more base stations, remote radio heads, etc.) on the one or more UL channels and DL channels. Depending on the capabilities of the UE 102 and the UE's configuration by the network, the UE 102 may communicate with the one or more network devices 104-1, 104-2 simultaneously, contemporaneously (e.g., in a multiple input multiple output (MIMO) mode), or sequentially (e.g., when handed over).

In some cases, the UE 102 may be connected to a first network device 104-1 in a radio resource control (RRC) connected mode state, and a second network device 104-2 may belong to a neighbor cell of the cell containing the first network device 104-1. For radio resource management (RRM) purposes (e.g., mobility management), the UE 102 may measure one or more signals transmitted by the second network device 104-2 (e.g., to determine whether the UE 102 should be handed over to the second network device 104-2 or communicate with both the first network device 104-1 and the second network device 104-2).

In some embodiments, the UE 102 may have a main radio (or transceiver) that can be used for RRM purposes and data/control reception/transmission, and a LP-WUR that is operable at a much lower power level than the main radio (e.g., in some cases, an order of magnitude or two less power than the main radio). The LP-WUR may support limited functionality, such as the monitoring/detection of a LP-WUS when the UE 102 is in an RRC inactive mode state or an RRC idle mode state with respect to a network device.

When the main radio is used for RRM purposes (e.g., when the UE 102 is in an RRC connected mode state), the measurement of a reference signal (RS) transmitted by a network device may be measured without a measurement gap (MG) if the RS (e.g., a synchronization signal block (SSB)) is inside an active bandwidth part (BWP) of the UE 102, but may need to be measured in a measurement gap if the RS is outside an active BWP of the UE 102. When the RS is within an active BWP of the UE 102, the RS may be measured without a scheduling restriction if the RS and data/control reception/transmission of the main radio use a same numerology (e.g., a same subcarrier spacing (SCS) on the same carrier in a first frequency range (e.g., FR1)) and same receive (Rx) beam (e.g., in a second frequency range (e.g., FR2)). However, the RS may need to be measured with a scheduling restriction if the RS and data/control reception/transmission of the main radio use a mixed numerology and/or different Rx beams.

In some cases, the second network device 104-2 may transmit various reference signals including, for example, a SSB. The second network device 104-2 may also transmit one or more LP-WUSs, to wake one or more UEs that are in an RRC inactive mode state or an RRC idle mode state with respect to the second network device 104-2. Conventionally, the UE 102 would measure the SSB transmitted by the second network device 104-2 for RRM purposes. However, if the UE 102 includes both a main radio (or transceiver) and a LP-WUR, the UE 102 may 1) use the LP-WUR to monitor for a LP-WUS transmitted by the first network device 104-1 when in an RRC inactive mode state or an RRC idle mode state with respect to the first network device 104-1, and/or 2) as described herein, use the main radio to measure the SSB or, additionally or alternatively, use the LP-WUR to measure the LP-WUS (e.g., as a cell-specific RS), for RRM purposes when in an RRC connected mode state with respect to the first network device 104-1. As an example of the second point, the UE 102 may adaptively switch between measuring a legacy reference signal (RS), such as an SSB, or measuring a LP-WUS, for RRM purposes.

Because the LP-WUR may consume an order of magnitude or more less power than the main radio, the LP-WUR may be operated with negligible additional power consumption while the main radio is in use. In some embodiments, the LP-WUR may be used for RRM purposes when it would increase the throughput of the main radio, such as, when use of the LP-WUR would enable the main radio to avoid incurring a measurement gap and/or a scheduling restriction.

In some embodiments, the UE 102 may perform RRM measurements for one or more frequency ranges (FRs), such as a first frequency range (FR1, e.g., a lower frequency range, in which the UE 102 or network devices 104-1, 104-2 may transmit on a single beam) or a second frequency range (FR2, e.g., a higher frequency range, in which the UE 102 or network devices 104-1, 104-2 may transmit/receive on multiple beams). In some embodiments, the UE 102 may perform RRM measurements for one or more transmit (Tx) beams of the network devices 104-1, 104-2 and/or one or more Rx beams of the UE 102.

For a UE that has a main radio (also referred to herein as a transceiver) and a WUR (e.g., a LP WUR), the UE may have one or more capabilities that relate to the UE's use of these radios. The UE may be programmed to implement the capabilities, and in some cases may be configured to report the capabilities to a network-either reactively, in response to a request to provide the capabilities, or proactively, in the absence of a request to provide the capabilities.

A first capability may be a capability to receive a LP-WUS using the LP-WUR. The first capability may indicate, to a network, that the UE has a LP-WUR and can receive a LP-WUS. The first capability may be indicated per UE (indicating that the UE can receive a LP-WUS regardless of FR, band, or per band per band combination), or per FR, or per band (i.e., per frequency band), or per band per band combination.

A second capability may indicate whether the UE supports mobility measurement based on a LP-WUS (e.g., measurement of one or more LP-WUSs transmitted by one or more neighbor cells). The first capability may be indicated per UE, or per FR, or per band, or per band per band combination. Having the first capability may be a pre-requisite to having the second capability.

A third capability may indicate whether the UE can receive a transmission via the LP-WUR while simultaneously using the main radio (or transceiver) to transmit or receive. The third capability may be indicated per UE, or per FR, or per band, or per band per band combination.

Having at least one of the first capability or second capability may be a pre-requisite to having the third capability.

In some embodiments, the third capability may be associated with a condition, such as a condition indicating that the third capability is “without interruption” or “with interruption.” “Without interruption” means that, when the UE uses the main radio (or transceiver) and LP-WUR simultaneously, or when the UE turns ON or turns OFF one of the radios (e.g., the main radio (or transceiver) or the LP-WUR), a use or switching event associated with one of the radios will not interrupt the UE's use of the other radio. “With interruption” means that, when the UE uses the main radio (or transceiver) and LP-WUR simultaneously, or when the UE turns ON or turns OFF one of the radios (e.g., the main radio (or transceiver) or the LP-WUR), a use or switching event associated with one of the radios will not interrupt the UE's use of the other radio.

A fourth capability may indicate whether the main radio (or transceiver) and the LP-WUR can receive simultaneous transmissions with different numerologies (e.g., different subcarrier spacing (SCS), such as different SCS for a legacy reference signal (RS) (e.g., a SSB) received using the main radio and a LP-WUS received using the LP-WUR). The fourth capability may be indicated per UE, or per FR, or per band, or per band per band combination. Having at least the third capability may be a pre-requisite to having the fourth capability.

A fifth capability may indicate whether the main radio (or transceiver) and the LP-WUR can receive simultaneous transmissions on different Rx beams of the UE (e.g., in FR2). A UE that has the fifth capability may receive, at the same time, and by way of example, a legacy RS (e.g., a SSB) on a first Rx beam and a LP-WUS on a second Rx beam. The fifth capability may be indicated per UE, or per FR, or per band, or per band per band combination. Having at least the third capability may be a pre-requisite to having the fifth capability.

Each of the first through fifth capabilities, or some subset thereof, may be indicated to the network. In some embodiments, each capability may be indicated in an information element (IE), or in a field of an IE. Different capabilities may be indicated in the same or different IEs, or in the same or different fields of an IE.

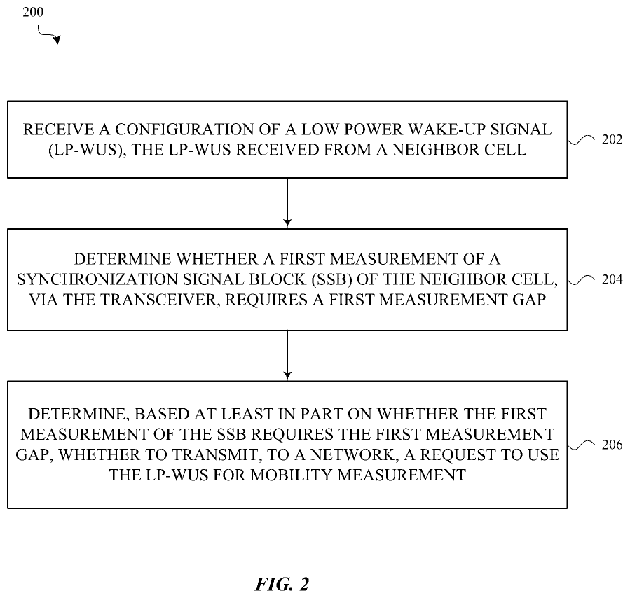

FIG. 2 shows an example method 200 of wireless communication by a UE. In some cases, the UE may be the UE described with reference to FIG. 1 or one of the other UEs described herein. The method 200 may be performed using a processor, a main radio (or transceiver), a WUR (e. g, a LP WUR), or other components of the UE.

At 202, the method 200 may include receiving a configuration of a LP-WUS. The LP-WUS may be received from a neighbor cell. In some embodiments, the configuration of the LP-WUS may be received via the transceiver.

At 204, the method 200 may include determining whether a first measurement of a SSB (or other legacy RS) of the neighbor cell, via the transceiver, requires a first measurement gap.

At 206, the method 200 may include determining, based at least in part on whether the first measurement of the SSB requires the first measurement gap, whether to transmit, to a network, a request to use the LP-WUS for mobility measurement. In some embodiments, the determination of whether to transmit the request to use the LP-WUS for mobility management may be made while the UE is operated in an RRC connected mode state without connected mode discontinuous reception (CDRX) enabled. In some embodiments, all of the operations of the method 200 may be performed while the UE is operated in a RRC connected mode state without CDRX enabled.

The method 200 may be variously embodied, extended, or adapted, as described in the following paragraphs and elsewhere in this description.

In some embodiments of the method 200, the method 200 may further include determining whether a second measurement of the LP-WUS, via the LP-WUR, requires a second measurement gap. In some of these embodiments, the method 200 may include determining the first measurement of the SSB requires the first measurement gap (e.g., because the SSB is outside an active bandwidth part (BWP) of the UE); determining the second measurement of the LP-WUS does not require the second measurement gap (e.g., because the LP-WUS is inside an active BWP of the UE, or inside an active operation bandwidth (BW) of the LP-WUR); and requesting to perform the second measurement of the LP-WUS (i.e., the measurement of the LP-WUS via the LP-WUR) for mobility measurement. In some embodiments, the request to perform the second measurement of the LP-WUS may be considered a request to switch the RS used by the UE for RRM measurement. In some embodiments, the method 200 may include determining whether an acknowledgement (ACK) of the request is received from the network; and determining whether to perform the second measurement of the LP-WUS, for mobility measurement, based at least in part on whether the acknowledgement of the request is received from the network. In other words, and in some embodiments, the UE may only perform the second measurement of the LP-WUS, for mobility measurement, when allowed to do so by the network. In some embodiments, the UE may receive a non-acknowledgement (NACK) from the network when not authorized to perform the second measurement of the LP-WUS for mobility measurement. In some embodiments, the UE may interpret the absence of an ACK from the network as a NACK. Using the LP-WUS for RRM measurement in these embodiments, instead of the SSB, can increase the throughput of the transceiver by avoiding having to incur the first measurement gap.

In some embodiments of the method 200 where the method includes determining whether the second measurement of the LP-WUS, via the LP-WUR, requires a second measurement gap, the method 200 may further include determining the first measurement of the SSB does not require the first measurement gap (e.g., because the SSB is inside an active BWP of the UE); determining the second measurement of the LP-WUS requires the second measurement gap (e.g., because the LP-WUS is outside an active BWP of the UE, or outside an active operation BW of the LP-WUR); and performing the first measurement of the SSB without the first measurement gap (e.g., for RRM measurement). Although the LP-WUS could be measured in this scenario, there may not be an advantage to using the LP-WUS (given that the transceiver will still have to experience the second measurement gap), and receiving/measuring the SSB may provide a more robust RRM measurement. This may be a default solution, and may not require the UE to request or receive an ACK from the network. In some cases, the method 200 may alternatively include determining the first measurement of the SSB does require the first measurement gap (e.g., because the SSB is outside an active BWP of the UE); determining the second measurement of the LP-WUS requires the second measurement gap (e.g., because the LP-WUS is outside an active BWP of the UE, or outside an active operation BW of the LP-WUR); and performing the first measurement of the SSB during the first measurement gap (e.g., for RRM measurement). Thus, whenever the LP-WUS requires the second measurement gap, the method 200 may default to performing the first measurement of the SSB.

In some embodiments of the method 200, the method 200 may further include determining the first measurement of the SSB does not require the first measurement gap. In these embodiments, the method 200 may further include determining whether the first measurement of the SSB of the neighbor cell, via the transceiver, requires a first scheduling restriction, and determining whether to transmit the request to use the LP-WUS for mobility measurement, at 206, based at least in part on whether the first measurement of the SSB requires the first scheduling restriction. When the first measurement of the SSB does not require the first scheduling restriction (or any scheduling restriction), the method 200 may include performing the first measurement of the SSB during the first measurement gap (e.g., for RRM measurement). Although the LP-WUS may be able to be measured in this scenario, there may not be an advantage to using the LP-WUS (given that the transceiver does not have to incur a scheduling restriction), and receiving/measuring the SSB may provide a more robust RRM measurement.

In some embodiments of the method 200 where the method includes determining whether the first measurement of the SSB of the neighbor cell, via the transceiver, requires the first scheduling restriction, the method 200 may further include determining whether the second measurement of the LP-WUS, via the LP-WUR, requires a second scheduling restriction (or any scheduling restriction). In some of these embodiments, the method 200 may further include determining the first measurement of the SSB requires the first scheduling restriction (e.g., due to a mixed numerology between the transceiver and the LP-WUR, or because different Rx beams are used by the transceiver and the LP-WUR (for FR2 only)); determining the second measurement of the LP-WUS does not require the second scheduling restriction (e.g., because the UE supports the fourth or fifth capability that was previously described); and requesting to perform the second measurement of the LP-WUS (i.e., the measurement of the LP-WUS via the LP-WUR) for mobility measurement. In some embodiments, the request to perform the second measurement of the LP-WUS may be considered a request to switch the RS used by the UE for RRM measurement. In some embodiments, the method 200 may include determining whether an ACK of the request is received from the network; and determining whether to perform the second measurement of the LP-WUS, for mobility measurement, based at least in part on whether the acknowledgement of the request is received from the network. In other words, and in some embodiments, the UE may only perform the second measurement of the LP-WUS, for mobility measurement, when allowed to do so by the network. In some embodiments, the UE may receive a NACK from the network when not authorized to perform the second measurement of the LP-WUS for mobility measurement. In some embodiments, the UE may interpret the absence of an ACK from the network as a NACK. Using the LP-WUS for RRM measurement in these embodiments, instead of the SSB, can increase the throughput of the transceiver by avoiding having to incur the first scheduling restriction.

In some embodiments of the method 200 where the method further includes determining whether the second measurement of the LP-WUS, via the LP-WUR, requires the second scheduling restriction, the method 200 may further include determining the first measurement of the SSB does not require the first scheduling restriction; determining the second measurement of the LP-WUS requires the second scheduling restriction (e.g., because the UE does not support the fourth or fifth capability that was previously described); and performing the first measurement of the SSB (e.g., for RRM measurement). Although the LP-WUS could be measured in this scenario, there may not be an advantage to using the LP-WUS (given that the transceiver will still have to experience the first scheduling restriction), and receiving/measuring the SSB may provide a more robust RRM measurement. This may be a default solution, and may not require the UE to request or receive an ACK from the network. In some cases, the method 200 may alternatively include determining the first measurement of the SSB does require the first scheduling restriction (e.g., due to a mixed numerology between the transceiver and the LP-WUR, or because different Rx beams are used by the transceiver and the LP-WUR (for FR2 only)); determining the second measurement of the LP-WUS requires the second scheduling restriction (e.g., because the UE does not support the fourth or fifth capability that was previously described); and performing the first measurement of the SSB with the first scheduling restriction (e.g., for RRM measurement). Thus, whenever the LP-WUS requires the second scheduling restriction, the method 200 may default to performing the first measurement of the SSB.

In the embodiments described in the preceding paragraphs, the UE may need to support, at least, each of the first through third capabilities that were previously described. In some embodiments, the method 200 may include transmitting a set of capabilities of the UE to the network, and the set of capabilities may indicate that: the UE is capable of receiving a LP-WUS using the LP-WUR; the UE supports mobility measurement based on the LP-WUS; and the UE can receive a transmission via the LP-WUR while simultaneously using the transceiver to transmit or receive. In some embodiments, the set of capabilities may include other capabilities of the UE, such as the fourth or fifth capability that was previously described.

Although FIG. 2 describes a method 200 that allows a UE, under some conditions, to request a network to use a LP-WUS for mobility measurement, a network that receives a set of capabilities from the UE may, in some cases, configure a UE to use a LP-WUS (instead of a SSB) for mobility measurement (e.g., when the set of capabilities include at least the first through third capabilities described herein). The network may consider the same factors set forth with reference to FIG. 2 and, when the factors suggest that the UE's use of the LP-WUS for mobility measurement would improve the throughput of the UE's main radio (or transceiver), the network may instruct the UE to use the LP-WUS instead of the SSB.

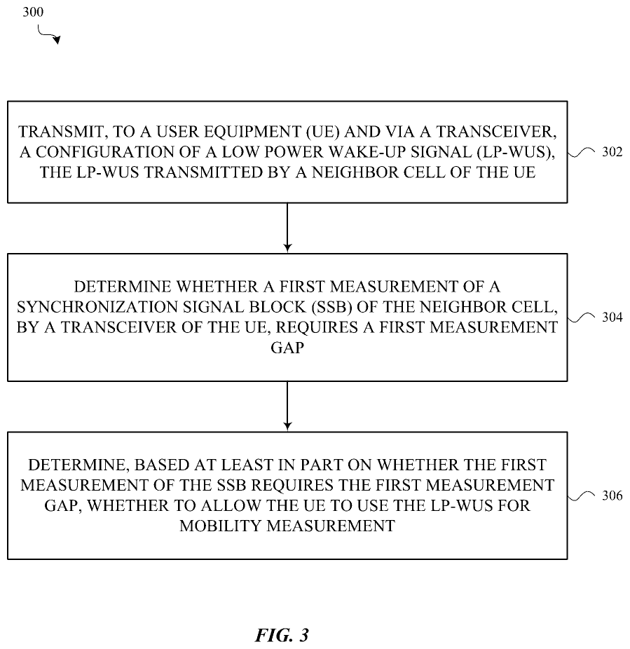

FIG. 3 shows an example method 300 of wireless communication by a network device (e.g., a network device of a RAN). In some cases, the network device may be the network device described with reference to FIG. 1 or one of the other network devices described herein. The method 300 may be performed using a processor, a main radio (or transceiver), or other components of the network device.

At 302, the method 300 may include transmitting, to a UE and via the transceiver, a configuration of a LP-WUS. The LP-WUS may be transmitted by a neighbor cell of the UE.

At 304, the method 300 may include determining whether a first measurement of a SSB (or other legacy RS) of the neighbor cell, by a main radio (or transceiver) of the UE, requires a first measurement gap.

At 306, the method 300 may include determining, based at least in part on whether the first measurement of the SSB requires the first measurement gap, whether to allow (or configure) the UE to use the LP-WUS for mobility measurement. In some embodiments, the determination of whether to allow (or configure) the UE to use the LP-WUS for mobility management may be made while the UE is operated in an RRC connected mode state without CDRX enabled. In some embodiments, all of the operations of the method 300 may be performed while the UE is operated in an RRC connected mode state without CDRX enabled.

The method 300 may be variously embodied, extended, or adapted, as described in the following paragraphs and elsewhere in this description.

In some embodiments of the method 300, the method 300 may further include determining whether a second measurement of the LP-WUS, via the LP-WUR of the UE, requires a second measurement gap. In some of these embodiments, the method 300 may include determining the first measurement of the SSB requires the first measurement gap (e.g., because the SSB is outside an active BWP of the UE); determining the second measurement of the LP-WUS does not require the second measurement gap (e.g., because the LP-WUS is inside an active BWP of the UE, or inside an active operation BW of the LP-WUR of the UE); and transmitting to the UE, via the transceiver, an indication that the UE is allowed (or configured) to perform the second measurement of the LP-WUS (i.e., the measurement of the LP-WUS via the LP-WUR of the UE) for mobility measurement. Allowing (or configuring) the UE to use the LP-WUS for RRM measurement in these embodiments, instead of the SSB, can increase the throughput of the UE's transceiver by enabling the UE's transceiver to avoid having to incur the first measurement gap.

In some embodiments of the method 300 where the method includes determining whether a second measurement of the LP-WUS, via the LP-WUR, requires a second measurement gap, the method 300 may further include determining the first measurement of the SSB does not require the first measurement gap (e.g., because the SSB is inside an active BWP of the UE); determining the second measurement of the LP-WUS requires the second measurement gap (e.g., because the LP-WUS is outside an active BWP of the UE, or outside an active operation BW of the LP-WUR of the UE); and transmitting to the UE, via the transceiver, at least one of 1) a first indication that the UE is not allowed to perform the second measurement of the LP-WUS, or 2) a second indication that the UE must perform the first measurement of the SSB (e.g., without the first measurement gap) (e.g., for RRM measurement). Although the LP-WUS could be measured by the UE in this scenario, there may not be an advantage to using the LP-WUS (given that the transceiver of the UE will still have to experience the second measurement gap), and receiving/measuring the SSB may provide a more robust RRM measurement. In some cases, the method 300 may alternatively include determining the first measurement of the SSB does require the first measurement gap (e.g., because the SSB is outside an active BWP of the UE); determining the second measurement of the LP-WUS requires the second measurement gap (e.g., because the LP-WUS is outside an active BWP of the UE, or outside an active operation BW of the LP-WUR); and transmitting to the UE, via the transceiver, at least one of 1) a first indication that the UE is not allowed to perform the second measurement of the LP-WUS, or 2) a second indication that the UE must perform the first measurement of the SSB (e.g., during the first measurement gap). Thus, whenever the LP-WUS requires the second measurement gap, the method 300 may default to instructing the UE to perform the first measurement of the SSB.

In some embodiments of the method 300, the method 300 may further include determining the first measurement of the SSB does not require the first measurement gap. In these embodiments, the method 300 may further include determining whether the first measurement of the SSB, via the transceiver of the UE, requires a first scheduling restriction, and determining whether to allow (or configure) the UE to use the LP-WUS for mobility measurement, at 306, based at least in part on whether the first measurement of the SSB requires the first scheduling restriction. When the first measurement of the SSB does not require the first scheduling restriction (or any scheduling restriction), the method 300 may include allowing (or configuring) the UE to perform the first measurement of the SSB during the first measurement gap (e.g., for RRM measurement). Although the LP-WUS may be able to be measured in this scenario, there may not be an advantage to allowing (or configuring) the UE to measure the LP-WUS (given that the transceiver of the UE does not have to incur a scheduling restriction), and receiving/measuring the SSB may provide a more robust RRM measurement.

In some embodiments of the method 300 where the method includes determining whether the first measurement of the SSB, via the transceiver of the UE, requires the first scheduling restriction, the method 300 may further include determining whether the second measurement of the LP-WUS, via the LP-WUR, requires a second scheduling restriction (or any scheduling restriction). In some of these embodiments, the method 200 may further include determining the first measurement of the SSB requires the first scheduling restriction (e.g., due to a mixed numerology between the transceiver of the UE and the LP-WUR of the UE, or because different Rx beams are used by the transceiver of the UE and the LP-WUR of the UE (for FR2 only)); determining the second measurement of the LP-WUS does not require the second scheduling restriction (e.g., because the UE supports the fourth or fifth capability that was previously described); and transmitting to the UE, via the transceiver, an indication that the UE is allowed (or configured) to perform the second measurement of the LP-WUS (i.e., the measurement of the LP-WUS via the LP-WUR of the UE) for mobility measurement. Allowing (or configuring) the UE to use the LP-WUS for RRM measurement in these embodiments, instead of the SSB, can increase the throughput of the UE's transceiver, by enabling the UE's transceiver to avoid having to incur the first scheduling restriction.

In some embodiments of the method 300 where the method further includes determining whether the second measurement of the LP-WUS, via the LP-WUR of the UE, requires the second scheduling restriction, the method 200 may further include determining the first measurement of the SSB does not require the first scheduling restriction; determining the second measurement of the LP-WUS requires the second scheduling restriction (e.g., because the UE does not support the fourth or fifth capability that was previously described); and transmitting to the UE, via the transceiver, at least one of 1) a first indication that the UE is not allowed (or configured) to perform the second measurement of the LP-WUS, or 2) a second indication that the UE must perform the first measurement of the SSB (e.g., for RRM measurement). Although the LP-WUS could be measured in this scenario, there may not be an advantage to using the LP-WUS (given that the transceiver will still have to experience the first scheduling restriction), and receiving/measuring the SSB may provide a more robust RRM measurement. This may be a default solution, and may not require the UE to request or receive an ACK from the network. In some cases, the method 300 may alternatively include determining the first measurement of the SSB does require the first scheduling restriction (e.g., due to a mixed numerology between the transceiver and the LP-WUR, or because different Rx beams are used by the transceiver and the LP-WUR (for FR2 only)); determining the second measurement of the LP-WUS requires the second scheduling restriction (e.g., because the UE does not support the fourth or fifth capability that was previously described); and transmitting to the UE, via the transceiver, at least one of 1) a first indication that the UE is not allowed (or configured) to perform the second measurement of the LP-WUS, or 2) a second indication that the UE must perform the first measurement of the SSB (e.g., for RRM measurement).

In the embodiments described in the preceding paragraphs, the UE may need to support, at least, each of the first through third capabilities that were previously described. In some embodiments, the method 300 may include receiving a set of capabilities of the UE, and the set of capabilities may indicate that: the UE is capable of receiving a LP-WUS using a LP-WUR of the UE; the UE supports mobility measurement based on the LP-WUS; and the UE can receive a transmission via the LP-WUR while simultaneously using the transceiver to transmit or receive. In some embodiments, the set of capabilities may include other capabilities of the UE, such as the fourth or fifth capability that was previously described.

Although FIG. 3 describes a method 300 that allows (or configures) a UE, under some conditions, to use a LP-WUS (instead of a SSB) for mobility measurement (e.g., when a set of capabilities of the UE include at least the first through third capabilities described herein), a network device may alternatively receive, from the UE, a request to use a LP-WUS for mobility measurement. When considering whether to grant the request, the network may consider the same factors set forth with reference to FIG. 3 and, when the factors suggest that the UE's use of the LP-WUS for mobility measurement would improve the throughput of the UE's main radio (or transceiver), the network may instruct the UE to use the LP-WUS instead of the SSB.

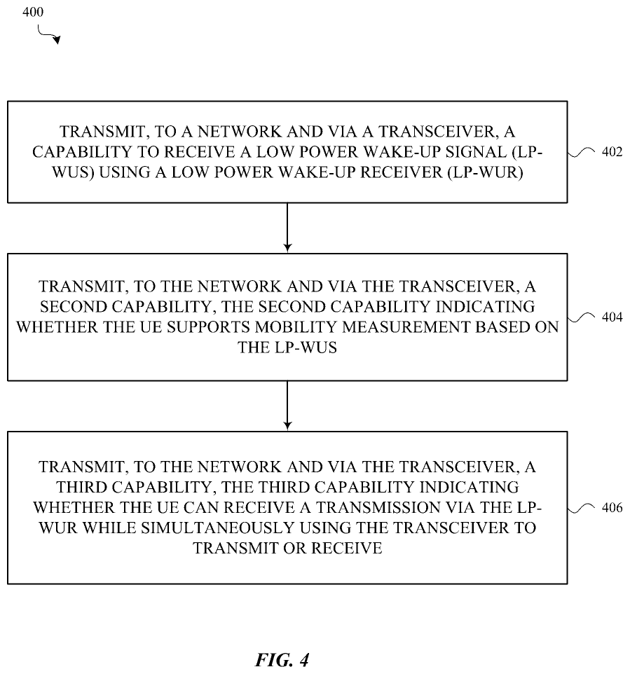

FIG. 4 shows another example method 400 of wireless communication by a UE. In some cases, the UE may be the UE described with reference to FIG. 1 or 2, or one of the other UEs described herein. The method 400 may be performed using a processor, a main radio (or transceiver), or other components of the UE.

At 402, the method 400 may include transmitting, to a network and via the transceiver, a first capability to receive a LP-WUS using the LP-WUR.

At 404, the method 400 may include transmitting, to the network and via the transceiver, a second capability. The second capability may indicate whether the UE supports mobility measurement based on the LP-WUS.

At 406, the method 400 may include transmitting, to the network and via the transceiver, a third capability. The third capability may indicate whether the UE can receive a transmission via the LP-WUR while simultaneously using the transceiver to transmit or receive.

The method 400 may be variously embodied, extended, or adapted, as described in the following paragraphs and elsewhere in this description.

In some embodiments, the method 400 may further include transmitting, to the network and via the transceiver, at least one of a fourth capability or a fifth capability. The fourth capability may indicate whether the main radio (or transceiver) and the LP-WUR can receive simultaneous transmissions with different numerologies. The fifth capability may indicate whether the transceiver and the LP-WUR can receive simultaneous transmissions on different Rx beams of the UE.

Embodiments contemplated herein include one or more non-transitory computer-readable media storing instructions to cause an electronic device, upon execution of the instructions by one or more processors of the electronic device, to perform one or more elements of the method 200, 300, or 400. In the context of method 200 or 400, this non-transitory computer-readable media may be, for example, a memory of a UE (such as a memory 606 of a wireless device 602 that is a UE, as described herein). In the context of method 300, this non-transitory computer-readable media may be, for example, a memory of a network device (such as a memory 624 of a network device 620, as described herein).

Embodiments contemplated herein include an apparatus having logic, modules, or circuitry to perform one or more elements of the method 200, 300, or 400. In the context of method 200 or 400, this apparatus may be, for example, an apparatus of a UE (such as a wireless device 602 that is a UE, as described herein). In the context of method 300, this apparatus may be, for example, an apparatus of a network device (such as a network device 620, as described herein).

Embodiments contemplated herein include an apparatus having one or more processors and one or more computer-readable media, using or storing instructions that, when executed by the one or more processors, cause the one or more processors to perform one or more elements of the method 200, 300, or 400. In the context of method 200 or 400, this apparatus may be, for example, an apparatus of a UE (such as a wireless device 602 that is a UE, as described herein). In the context of the method 300, this apparatus may be, for example, an apparatus of a network device (such as a network device 620, as described herein).

Embodiments contemplated herein include a signal as described in or related to one or more elements of the method 200, 300, or 400.

Embodiments contemplated herein include a computer program or computer program product having instructions, wherein execution of the program by a processor causes the processor to carry out one or more elements of the method 200, 300, or 400. In the context of method 200 or 400, the processor may be a processor of a UE (such as a processor(s) 604 of a wireless device 602 that is a UE, as described herein), and the instructions may be, for example, located in the processor and/or on a memory of the UE (such as a memory 606 of a wireless device 602 that is a UE, as described herein). In the context of method 300, the processor may be a processor of a network device (such as a processor(s) 622 of a network device 620, as described herein), and the instructions may be, for example, located in the processor and/or on a memory of the network device (such as a memory 624 of a network device 620, as described herein).

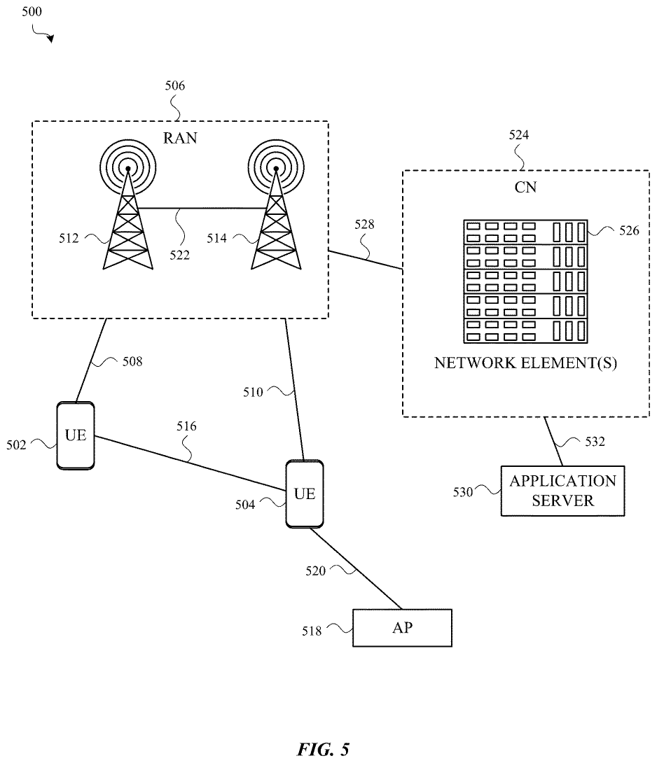

FIG. 5 illustrates an example architecture of a wireless communication system, according to embodiments described herein. The following description is provided for an example wireless communication system 500 that operates in conjunction with the LTE system standards or specifications and/or 5G or NR system standards or specifications, as provided by 3GPP technical specifications.

As shown by FIG. 5, the wireless communication system 500 includes UE 502 and UE 504 (although any number of UEs may be used). In this example, the UE 502 and the UE 504 are illustrated as smartphones (e.g., handheld touchscreen mobile computing devices connectable to one or more cellular networks), but may also comprise any mobile or non-mobile computing device configured for wireless communication.

The UE 502 and UE 504 may be configured to communicatively couple with a RAN 506. In embodiments, the RAN 506 may be NG-RAN, E-UTRAN, etc. The UE 502 and UE 504 utilize connections (or channels) (shown as connection 508 and connection 510, respectively) with the RAN 506, each of which comprises a physical communications interface. The RAN 506 can include one or more network devices, such as base station 512 and base station 514, that enable the connection 508 and connection 510.

In this example, the connection 508 and connection 510 are air interfaces to enable such communicative coupling, and may be consistent with RAT(s) used by the RAN 506, such as, for example, an LTE and/or NR.

In some embodiments, the UE 502 and UE 504 may also directly exchange communication data via a sidelink interface 516. The UE 504 is shown to be configured to access an access point (shown as AP 518) via connection 520. By way of example, the connection 520 can comprise a local wireless connection, such as a connection consistent with any IEEE 802.11 protocol, wherein the AP 518 may comprise a Wi-Fi® router. In this example, the AP 518 may be connected to another network (for example, the Internet) without going through a CN 524.

In embodiments, the UE 502 and UE 504 can be configured to communicate using orthogonal frequency division multiplexing (OFDM) communication signals with each other or with the base station 512 and/or the base station 514 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 512 or base station 514 may be implemented as one or more software entities running on server computers as part of a virtual network. In addition, or in other embodiments, the base station 512 or base station 514 may be configured to communicate with one another via interface 522. In embodiments where the wireless communication system 500 is an LTE system (e.g., when the CN 524 is an EPC), the interface 522 may be an X2 interface. The X2 interface may be defined between two or more network devices of a RAN (e.g., two or more eNBs and the like) that connect to an EPC, and/or between two eNBs connecting to the EPC. In embodiments where the wireless communication system 500 is an NR system (e.g., when CN 524 is a 5GC), the interface 522 may be an Xn interface. The Xn interface is defined between two or more network devices of a RAN (e.g., two or more gNBs and the like) that connect to the 5GC, between a base station 512 (e.g., a gNB) connecting to the 5GC and an eNB, and/or between two eNBs connecting to the 5GC (e.g., CN 524).

The RAN 506 is shown to be communicatively coupled to the CN 524. The CN 524 may comprise one or more network elements 526, which are configured to offer various data and telecommunications services to customers/subscribers (e.g., users of UE 502 and UE 504) who are connected to the CN 524 via the RAN 506. The components of the CN 524 may be implemented in one physical device or separate physical devices including components to read and execute instructions from a machine-readable or computer-readable medium (e.g., a non-transitory machine-readable storage medium).

In embodiments, the CN 524 may be an EPC, and the RAN 506 may be connected with the CN 524 via an S1 interface 528. In embodiments, the S1 interface 528 may be split into two parts, an S1 user plane (S1-U) interface, which carries traffic data between the base station 512 or base station 514 and a serving gateway (S-GW), and the S1-MME interface, which is a signaling interface between the base station 512 or base station 514 and mobility management entities (MMEs).

In embodiments, the CN 524 may be a 5GC, and the RAN 506 may be connected with the CN 524 via an NG interface 528. In embodiments, the NG interface 528 may be split into two parts, an NG user plane (NG-U) interface, which carries traffic data between the base station 512 or base station 514 and a user plane function (UPF), and the S1 control plane (NG-C) interface, which is a signaling interface between the base station 512 or base station 514 and access and mobility management functions (AMFs).

Generally, an application server 530 may be an element offering applications that use internet protocol (IP) bearer resources with the CN 524 (e.g., packet switched data services). The application server 530 can also be configured to support one or more communication services (e.g., VoIP sessions, group communication sessions, etc.) for the UE 502 and UE 504 via the CN 524. The application server 530 may communicate with the CN 524 through an IP communications interface 532.

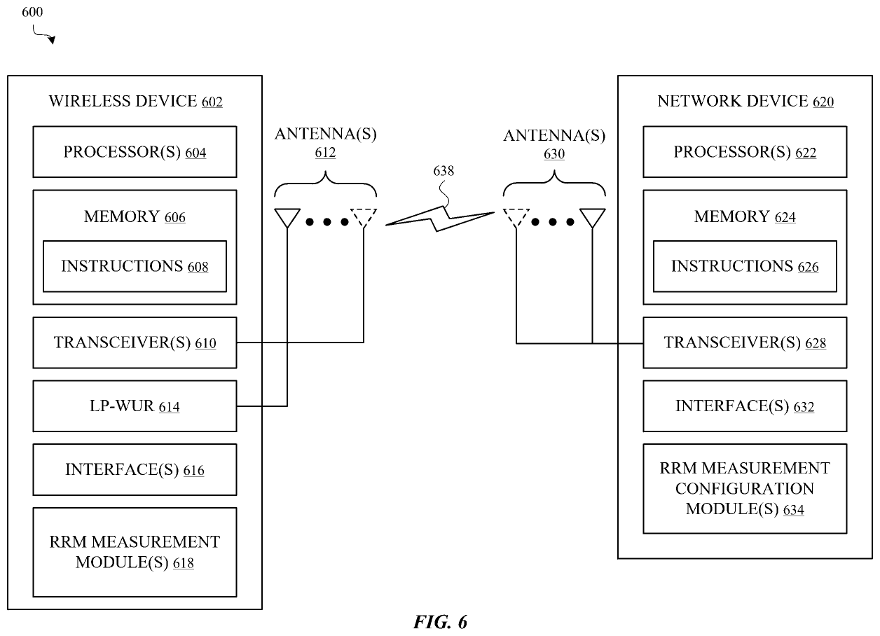

FIG. 6 illustrates an example system 600 for performing signaling 638 between a wireless device 602 and a network device 620, according to embodiments described herein. The system 600 may be a portion of a wireless communication system as herein described. The wireless device 602 may be, for example, a UE of a wireless communication system. The network device 620 may be, for example, a base station (e.g., an eNB or a gNB) or a radio head of a wireless communication system.

The wireless device 602 may include one or more processor(s) 604. The processor(s) 604 may execute instructions such that various operations of the wireless device 602 are performed, as described herein. The processor(s) 604 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 602 may include a memory 606. The memory 606 may be a non-transitory computer-readable storage medium that stores instructions 608 (which may include, for example, the instructions being executed by the processor(s) 604). The instructions 608 may also be referred to as program code or a computer program. The memory 606 may also store data used by, and results computed by, the processor(s) 604.

The wireless device 602 may include one or more transceiver(s) 610 (also collectively referred to as a transceiver 610) that may include radio frequency (RF) transmitter and/or receiver circuitry that use the antenna(s) 612 of the wireless device 602 to facilitate signaling (e.g., the signaling 638) to and/or from the wireless device 602 with other devices (e.g., the network device 620) according to corresponding RATs. The wireless device 602 may also include a LP-WUR 614 that enables the wireless device 602 to detect and/or measure, using the antenna(s) 612, a LP-WUS received from one or more other devices.

The wireless device 602 may include one or more antenna(s) 612 (e.g., one, two, four, eight, or more). For embodiments with multiple antenna(s) 612, the wireless device 602 may leverage the spatial diversity of such multiple antenna(s) 612 to send and/or receive multiple different data streams on the same time and frequency resources. This behavior may be referred to as, for example, MIMO behavior (referring to the multiple antennas used at each of a transmitting device and a receiving device that enable this aspect). MIMO transmissions by the wireless device 602 may be accomplished according to precoding (or digital beamforming) that is applied at the wireless device 602 that multiplexes the data streams across the antenna(s) 612 according to known or assumed channel characteristics such that each data stream is received with an appropriate signal strength relative to other streams and at a desired location in the spatial domain (e.g., the location of a receiver associated with that data stream). Some embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In some embodiments having multiple antennas, the wireless device 602 may implement analog beamforming techniques, whereby phases of the signals sent by the antenna(s) 612 are relatively adjusted such that the (joint) transmission of the antenna(s) 612 can be directed (this is sometimes referred to as beam steering).

The wireless device 602 may include one or more interface(s) 616. The interface(s) 616 may be used to provide input to or output from the wireless device 602. For example, a wireless device 602 that is a UE may include interface(s) 616 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 610/antenna(s) 612 already described) that allow for communication between the UE and other devices and may operate according to known protocols (e.g., Wi-Fi®, Bluetooth®, and the like).

The wireless device 602 may include RRM measurement module(s) 618. The RRM measurement module(s) 618 may be implemented via hardware, software, or combinations thereof. For example, the RRM measurement module(s) 618 may be implemented as a processor, circuit, and/or instructions 608 stored in the memory 606 and executed by the processor(s) 604. In some examples, the RRM measurement module(s) 618 may be integrated within the processor(s) 604 and/or the transceiver(s) 610. For example, the RRM measurement module(s) 618 may be implemented by a combination of software components (e.g., executed by a DSP or a general processor) and hardware components (e.g., logic gates and circuitry) within the processor(s) 604 or the transceiver(s) 610.

The RRM measurement module(s) 618 may be used for various aspects of the present disclosure, for example, aspects of FIGS. 1-9, from a wireless device or UE perspective. The RRM measurement module(s) 618 may be configured to, for example, determine to use the transceiver(s) 610 or LP-WUR 614 for RRM measurement, and/or to transmit a set of UE capabilities related to RRM measurement to the network device 620.

The network device 620 may include one or more processor(s) 622. The processor(s) 622 may execute instructions such that various operations of the network device 620 are performed, as described herein. The processor(s) 622 may include one or more baseband processors implemented using, for example, a CPU, a DSP, an ASIC, a controller, an FPGA device, another hardware device, a firmware device, or any combination thereof configured to perform the operations described herein.

The network device 620 may include a memory 624. The memory 624 may be a non-transitory computer-readable storage medium that stores instructions 626 (which may include, for example, the instructions being executed by the processor(s) 622). The instructions 626 may also be referred to as program code or a computer program. The memory 624 may also store data used by, and results computed by, the processor(s) 622.

The network device 620 may include one or more transceiver(s) 628 (also collectively referred to as a transceiver 628) that may include RF transmitter and/or receiver circuitry that use the antenna(s) 630 of the network device 620 to facilitate signaling (e.g., the signaling 638) to and/or from the network device 620 with other devices (e.g., the wireless device 602) according to corresponding RATs.

The network device 620 may include one or more antenna(s) 630 (e.g., one, two, four, or more). In embodiments having multiple antenna(s) 630, the network device 620 may perform MIMO, digital beamforming, analog beamforming, beam steering, etc., as has been described.

The network device 620 may include one or more interface(s) 632. The interface(s) 632 may be used to provide input to or output from the network device 620. For example, a network device 620 of a RAN (e.g., a base station, a radio head, etc.) may include interface(s) 632 made up of transmitters, receivers, and other circuitry (e.g., other than the transceiver(s) 628/antenna(s) 630 already described) that enables the network device 620 to communicate with other equipment in a network, and/or that enables the network device 620 to communicate with external networks, computers, databases, and the like for purposes of operations, administration, and maintenance of the network device 620 or other equipment operably connected thereto.

The network device 620 may include one or more RRM measurement configuration module(s) 634. The RRM measurement configuration module(s) 634 may be implemented via hardware, software, or combinations thereof. For example, the RRM measurement configuration module(s) 634 may be implemented as a processor, circuit, and/or instructions 626 stored in the memory 624 and executed by the processor(s) 622. In some examples, the RRM measurement configuration module(s) 634 may be integrated within the processor(s) 622 and/or the transceiver(s) 628. For example, the RRM measurement configuration module(s) 634 may be implemented by a combination of software components (e.g., executed by a DSP or a general processor) and hardware components (e.g., logic gates and circuitry) within the processor(s) 622 or the transceiver(s) 628.

The RRM measurement configuration module(s) 634 may be used for various aspects of the present disclosure, for example, aspects of FIGS. 1-4, from a network device perspective. The RRM measurement configuration module(s) 634 may be configured to, for example, configure the wireless device 602 to use the transceiver(s) 610 or LP-WUR 614 for RRM measurement, and/or to receive a set of capabilities related to RRM measurement from the wireless device 602.

For one or more embodiments, at least one of the components set forth in one or more of the preceding figures may be configured to perform one or more operations, techniques, processes, and/or methods as set forth herein. For example, a baseband processor (or processor) as described herein in connection with one or more of the preceding figures may be configured to operate in accordance with one or more of the examples set forth herein. For another example, circuitry associated with a UE, network device, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form described. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

The systems described herein pertain to specific embodiments but are provided as examples. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. An apparatus comprising memory coupled to a processor, the processor configured to:
receive a configuration of a low power wake-up signal (LP-WUS), the LP-WUS received from a neighbor cell;
determine whether a first measurement of a synchronization signal block (SSB) of the neighbor cell requires a first measurement gap; and
determine, based at least in part on whether the first measurement of the SSB requires the first measurement gap, whether to transmit, to a network, a request to use the LP-WUS for mobility measurement.

2. The apparatus of claim 1, wherein the determination of whether to transmit the request to use the LP-WUS for mobility management is made while the UE is operated in a radio resource control (RRC) connected mode state without connected mode discontinuous reception (CDRX) enabled.

3. The apparatus of claim 1, wherein:
the processor is configured to determine whether a second measurement of the LP-WUS, via a low power wake-up radio (LP WUR), requires a second measurement gap; and
the processor,
determines the first measurement of the SSB requires the first measurement gap;
determines the second measurement of the LP-WUS does not require the second measurement gap; and
requests to perform the second measurement of the LP-WUS for mobility measurement.

4. The apparatus of claim 3, wherein:
the processor is configured to,
determine whether an acknowledgement of the request is received from the network; and
determine whether to perform the second measurement of the LP-WUS, for mobility measurement, based at least in part on whether the acknowledgement of the request is received from the network.

5. The apparatus of claim 1, wherein:
the processor is configured to determine whether a second measurement of the LP-WUS, via a low power wake-up radio (LP WUR), requires a second measurement gap; and
the processor,
determines the first measurement of the SSB does not require the first measurement gap;
determines the second measurement of the LP-WUS requires the second measurement gap; and
performs the first measurement of the SSB without the first measurement gap.

6. The apparatus of claim 1, wherein:
the processor determines the first measurement of the SSB does not require the first measurement gap; and
the processor is configured to,
determine whether the first measurement of the SSB of the neighbor cell requires a first scheduling restriction; and
further determine whether to transmit the request to use the LP-WUS for mobility measurement based at least in part on whether the first measurement of the SSB requires the first scheduling restriction.

7. The apparatus of claim 6, wherein:
the processor is configured to determine whether a second measurement of the LP-WUS, via a low power wake-up radio (LP WUR), requires a second scheduling restriction; and
the processor,
determines the first measurement of the SSB requires the first scheduling restriction;
determines the second measurement of the LP-WUS does not require the second scheduling restriction; and
requests to perform the second measurement of the LP-WUS for mobility measurement.

8. The apparatus of claim 7, wherein:
the processor is configured to,
determine whether an acknowledgement of the request is received from the network; and
determine whether to perform the second measurement of the LP-WUS, for mobility measurement, at least in part based on whether the acknowledgement of the request is received from the network.

9. The apparatus of claim 6, wherein:
the processor is configured to determine whether a second measurement of the LP-WUS, via a low power wake-up radio (LP WUR), requires a second scheduling restriction; and
the processor,
determines the first measurement of the SSB does not require the first scheduling restriction;
determines the second measurement of the LP-WUS requires the second scheduling restriction; and
performs the first measurement of the SSB.

10. The apparatus of claim 1, wherein:
the processor is configured to transmit a set of capabilities of the UE; and
the set of capabilities indicate that,
the UE is capable of receiving the LP-WUS using a low power wake-up radio (LP WUR) of the UE;
the UE supports mobility measurement based on the LP-WUS; and
the UE can receive a transmission via the LP-WUR while simultaneously using a transceiver to transmit or receive.

11. An apparatus comprising memory coupled to a processor, the processor configured to:
transmit, to a user equipment (UE), a configuration of a low power wake-up signal (LP-WUS), the LP-WUS transmitted by a neighbor cell of the UE;
determine whether a first measurement of a synchronization signal block (SSB) of the neighbor cell, by the UE, requires a first measurement gap; and
determine, based at least in part on whether the first measurement of the SSB requires the first measurement gap, whether to allow the UE to use the LP-WUS for mobility measurement.

12. The apparatus of claim 11, wherein the determination of whether to allow the UE to use the LP-WUS for mobility management is made while the UE is in a radio resource control (RRC) connected mode state without connected mode discontinuous reception (CDRX) enabled.

13. The apparatus of claim 11, wherein:
the processor is configured to determine whether a second measurement of the LP-WUS, by a low power wake-up radio (LP-WUR) of the UE, requires a second measurement gap; and
the processor,
determines the first measurement of the SSB requires the first measurement gap;
determines the second measurement of the LP-WUS does not require the second measurement gap; and
transmits to the UE an indication that the UE is allowed to perform the second measurement of the LP-WUS.

14. The apparatus of claim 11, wherein:
the processor is configured to determine whether a second measurement of the LP-WUS, by a low power wake-up radio (LP-WUR) of the UE, requires a second measurement gap; and
the processor,
determines the first measurement of the SSB does not require the first measurement gap;
determines the second measurement of the LP-WUS requires the second measurement gap; and
transmits to the UE at least one of,
a first indication that the UE is not allowed to perform the second measurement of the LP-WUS; or
a second indication that the UE must perform the first measurement of the SSB.

15. The apparatus of claim 11, wherein:
the processor determines the first measurement of the SSB does not require the first measurement gap; and
the processor is configured to,
determine whether the first measurement of the SSB requires a first scheduling restriction; and
further determine whether to allow the UE to use the LP-WUS for mobility measurement based at least in part on whether the first measurement of the SSB requires the first scheduling restriction.

16. The apparatus of claim 15, wherein:
the processor is configured to determine whether a second measurement of the LP-WUS, via a low power wake-up radio (LP-WUR) of the UE, requires a second scheduling restriction; and
the processor,
determines the first measurement of the SSB requires the first scheduling restriction;
determines the second measurement of the LP-WUS does not require the second scheduling restriction; and
transmits to the UE an indication that the UE is allowed to perform the second measurement of the LP-WUS.

17. The apparatus of claim 15, wherein:
the processor is configured to determine whether a second measurement of the LP-WUS, via a low power wake-up radio (LP-WUR), requires a second scheduling restriction; and
the processor,
determines the first measurement of the SSB does not require the first scheduling restriction;
determines the second measurement of the LP-WUS requires the second scheduling restriction; and
transmits to the UE at least one of,
a first indication that the UE is not allowed to perform the second measurement of the LP-WUS; or
a second indication that the UE must perform the first measurement of the SSB.

18. The apparatus of claim 11, wherein:
the processor is configured to receive, a set of capabilities of the UE; and
the set of capabilities indicate that,
the UE is capable of receiving the LP-WUS using a low power wake-up radio (LP-WUR) of the UE;
the UE supports mobility measurement based on the LP-WUS; and
the UE can receive a transmission via the LP-WUR while simultaneously using a transceiver to transmit or receive.

19. An apparatus comprising memory coupled to a processor, the processor configured to:
transmit, to a network, a capability to receive a low power wake-up signal (LP-WUS) using a low power wake-up radio (LP WUR);
transmit, to the network a second capability, the second capability indicating whether the UE supports mobility measurement based on the LP-WUS; and
transmit, to the network, a third capability, the third capability indicating whether the UE can receive a transmission via the LP-WUR while simultaneously using a transceiver to transmit or receive.

20. The apparatus of claim 19, wherein the processor is configured to transmit, to the network, at least one of:
a fourth capability, the fourth capability indicating whether the transceiver and the LP-WUR can receive simultaneous transmissions with different numerologies; or
a fifth capability, the fifth capability indicating whether the transceiver and the LP-WUR can receive simultaneous transmissions on different receive (Rx) beams of the UE.
